(19) United States
(12) Patent Application Publication
(10) Pub. No.: US 2026/0195157 A1
(43) Pub. Date: Jul. 9, 2026

(54) OPERATING SYSTEM DOMAIN FAILURE STATUS MONITORING APPARATUS OF HYPERVISOR SYSTEM

(71) Applicant: PERSEUS CO., LTD, Siheung-si, Gyeonggi-do (KR)

(72) Inventor: Sang-Bum SUH, Seoul (KR)

(21) Appl. No.: 18/876,409

(22) PCT Filed: Dec. 28, 2022
(86) PCT No.: PCT/KR2022/021451

§ 371 Date: Sep. 12, 2025

(51) Int. Cl. G06F 9/455; G06F 11/30

(52) U.S. Cl. CPC G06F 9/45558; G06F 11/301; G06F 11/3024; G06F 2009/45591

(57) ABSTRACT

The present disclosure relates to a monitoring apparatus for monitoring a failure status of operating system domains in a hypervisor system.

The present disclosure relates to run multiple operating systems in a virtual machine environment by allocating underlying resources in order to use system resources of the hardware physical layer and the operating system layer of constituting multiple of different types of operating systems and control/application software; run multiple operating systems in a virtual machine environment having functions to notify the status of cascading failures for each of multiple operating system domains that correspond to multiple operating systems comprising the operating system layers; and include a hypervisor configuring a failure status monitoring manager that has a function of monitoring the failure status where the hypervisor collects the failure status by each of multiple operating system domains via interface and shares them with the multiple operating system domains.

According to the present disclosure, there is an effect of solving a situation where some operating system domains running on the hypervisor cause failures, resulting in cascading failures in which each operating system cannot operate properly according to its original specification on the hypervisor, leading to a problem where the rest of operating systems, especially operating systems with higher degrees of ASIL, cannot properly operate while meeting functional safety requirements.

### TECHNICAL FIELD

The present disclosure relates to a monitoring apparatus for monitoring a failure status of operating system domains of a hypervisor system. Specifically, it relates to a monitoring apparatus for monitoring a failure status of operating system domains of a hypervisor system that can prevent a problem where it cannot properly operate due to physical failures or logical failures in some operating systems running on the hypervisor causing cascading failures in the rest of operating system domains that are running in conjunction with the operating system domain on the hypervisor, while satisfying system requirements.

### BACKGROUND

Generally, hypervisor software is software that turns single computer hardware into multiple virtual computer hardware, and designing and developing hypervisor software requires a high level of technology similar to that of creating general purpose operating system software such as Windows and Linux.

Hypervisors have been used to help computing operations without interrupting banking services during an operating system update or hardware efficiency of the cloud data center.

Hypervisors are expected to be applied to various high-tech gadgets such as future vehicles, drones, and robots. Operating systems running on known hypervisors used to be a general purpose operating system such as Linux. Since it will be used in various fields of real-time systems such as automobile, drones, and robots, operating systems running on hypervisors are expected to include an operating system that guarantees a real-time operating system and functional safety. Furthermore, control/application software that guarantees the functional safety will be running on an operating system.

These hypervisors efficiently use computer hardware to run multiple operating systems at the same time, and they operate by allocating hardware resources to each operating system according to its given specification.

Meanwhile, among hardware resources, input/output devices such as networks, touch screens, and mice that are commonly used by multiple operating systems on a hypervisor may cause malfunctions that consume more resources than hardware resources already allocated according to its specification respectively.

For example, in a situation where hardware resources are used excessively, hardware resources already allocated according to its specification for each operating system on a hypervisor are insufficient, which may result in malfunctions of the operating system.

Since devices such as automobile, drones, and robots that will be applied in the future use a real-time operating system, when there are not enough hardware resources a real-time operating system will not be able to provide regular services causing malfunctions in systems of cars, drones, and robots.

Such problems are exemplarily described in detail with reference to FIGS. 1 and 2 as follows.

FIG. 1 is a structural diagram in which control/application software (e.g. AutoSAR) runs on a general purpose operating system (such as Linux) whereas FIG. 2 exemplarily depicts a structure in which control/application software (such as AutoSAR) of FIG. 1 is separated and configured on the hypervisor through a method of Automotive Safety Integrity Level (ASIL) decomposition in ISO26262 functional safety.

Referring to FIG. 1, the conventional system in FIG. 1 could not be defined as higher levels of ASIL due to the great complexity of a general purpose operating system (such as Linux). Referring to FIG. 2, it is implemented by structurally decomposing it into AutoSAR (QM: Quality Management) that does not require the ASIL rating and AutoSAR(ASIL) that requires the ASIL rating by applying a method of ASIL decomposition into control/application software (e.g. AutoSAR) of FIG. 1. Here, the operating system with higher degrees of ASIL applied is operated and AutoSAR(QM) is operated on a general purpose operating system.

In the structure of FIG. 2, it was difficult to apply a method of ASIL decomposition since there is no device in a hypervisor, which can prevent cascading failures between AutoSAR(QM) and AutoSAR(ASIL).

### PRIOR ART DOCUMENT

### Patent Document

Korean Patent Application Publication No. 10-2021-0127427 (Published on Oct. 22, 2021, title: Method and Apparatus for CPU Virtualization in Multicore Embedded System)
Korean Patent Application Publication No. 10-2021-0154769 (Published on Dec. 21, 2021, title: Micro Kernel-based Extensible Hypervisor)
Korean Patent Application Publication No. 10-2019-0029977 (Published on Mar. 21, 2019, title: A Control System for Device and Process for Operating the Control System)
Korean Patent Application Publication No. 10-2015-0090439 (Published on Aug. 6, 2015, title: Method for Scheduling a Task In Hypervisor for Many-core Systems)

### SUMMARY

A technical problem employed by the present disclosure is to solve the problems in which cascading failures occur in the rest of the operating system domains that were operating in conjunction with the corresponding operating systems on a hypervisor due to physical failures or logical failures of some operating system domains, making them difficult to operate while meeting system requirements.

Furthermore, a technical problem of the present disclosure is to solve problems such as cascading failures that each operating system cannot operate according to its original specification on the hypervisor, and the rest of operating system domains, especially operating systems with higher degrees of ASIL and higher degrees of control/application software, cannot operate properly while meeting functional safety requirements.

There are various communication channels (such as back-end Device Driver, Front-end Device Driver) between operating system domains on a hypervisor, enabling interdependent operations between operating systems. A more specific technical problem of the present disclosure is to prevent the effects of the failures on the whole, related operation system domains when cascading failures between the operating system domains happen.

A monitoring apparatus for monitoring a failure status of operating system domains of the hypervisor system according to the present disclosure in order to solve these technical problems is to run multiple operating systems in a virtual machine environment by allocating underlying resources in order to use system resources of the hardware physical layer and the operating system layer of constituting multiple of different types of operating systems and control/application software; run the multiple operating systems in a virtual machine environment having functions to notify the status of cascading failures for each of multiple operating system domains that correspond to multiple operating systems comprising the operating system layers; and include a hypervisor configuring a failure status monitoring manager that has a function of monitoring the failure status where the hypervisor collects the failure status by each of multiple operating system domains via interface and shares them with the multiple operating system domains.

In a monitoring apparatus for monitoring a failure status of operating system domains in a hypervisor system according to the present disclosure, the system resources include one or more of central processing unit resources, microcontroller unit resources, and memory resources.

In a monitoring apparatus for monitoring a failure status of operating system domains in a hypervisor system according to the present disclosure, a failure status monitoring manager that constitutes the hypervisor continuously tracks the state such as normal/malfunction state of the associated operating system domains via interface through which a hypervisor collects the state information of a certain operating system domain to share, and notifies the event signals throughout the system upon occurrence of a fault in the operating system domain of the hypervisor system, and delivers these notified event signals to a user.

In a monitoring apparatus for monitoring a failure status of operating system domains in a hypervisor system according to the present disclosure, the operating system layer is characterized in that it includes an operating system with one or more ASIL degrees, control/application software with one or more ASIL degrees, and one or more general-purpose operating system.

In a monitoring apparatus for monitoring a failure status of operating system domains in a hypervisor system according to the present disclosure, the failure monitoring manager is characterized in that it registers associated operating system domains and manages the association operations through an identification given to operating system domains on the hypervisor.

According to the present disclosure, there is an effect of solving a situation where some operating system domains running on the hypervisor cause failures, resulting in cascading failures in which each operating system cannot operate properly according to its original specification on the hypervisor, leading to a problem where the rest of operating systems, especially operating systems with higher degrees of ASIL, cannot properly operate while meeting functional safety requirements.

In addition, through the failure status information with which a hypervisor share on the operating system domains, there is an effect of fundamentally preventing cascading failure problems in operating system domains running on the hypervisor by being able to know the failure status of individual operating system in the ASIL decomposition software architecture.

In addition, there is an effect of solving problems such as a cascading failure in which each of operating systems on a hypervisor cannot properly operate according to its original specification as some operating system domains operating on a hypervisor cause failures, and a situation where the rest of operating system domains, especially operating systems with higher degrees of ASIL and control/application software with higher degrees of ASIL cannot operate properly while meeting functional safety requirements.

### BRIEF DESCRIPTION OF THE DRAWINGS

FIG. 1 is a structural diagram of the control/application software (e.g. AutoSAR) operating on a general purpose operating system (e.g. Linux) according to the prior art.

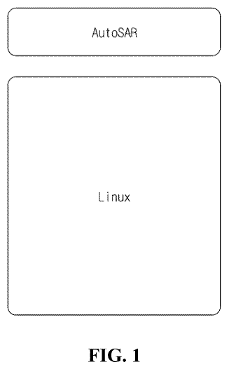

FIG. 2 is a diagram illustrating a structure in which the control/application software (e.g. AutoSAR) of FIG. 1 is separated through a method of Automotive Safety Integrity Level decomposition in ISO 26262: functional safety standard.

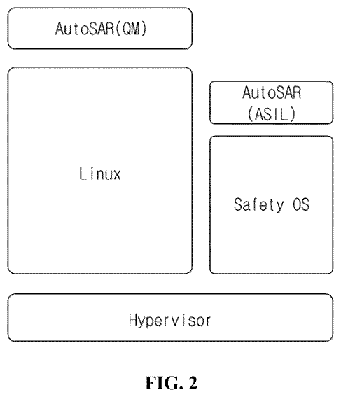

FIG. 3 is a diagram illustrating a failure status monitoring device of operating system domains on a hypervisor system according to an embodiment of the present disclosure.

FIG. 4 is a diagram exemplarily illustrating the configuration of a hypervisor according to an embodiment of the present disclosure.

FIG. 5 is a diagram illustrating an example of a system architecture in which a device driver domain is isolated from operating system domains according to an embodiment of the present disclosure.

FIG. 6 is a diagram illustrating an example of a system architecture in which a device driver domain is incorporated into an operating system domain according to an embodiment of the present disclosure.

### DESCRIPTION OF THE PREFERRED EMBODIMENTS

It is to be understood that the specific structural or functional description of embodiments of the present invention disclosed herein is for illustrative purposes only and is not intended to limit the scope of the inventive concept but may be embodied in many different forms and not limited to the embodiments set forth herein.

The embodiments according to the concept of the present invention can make various changes and can take various forms, so that the embodiments are illustrated in the drawings and described in detail herein. It should be understood, however, that it is not intended to limit the embodiments according to the concepts of the present invention to the particular forms disclosed, but includes all modifications, equivalents, or alternatives falling within the spirit and scope of the invention.

Unless defined otherwise, all terms including technical and/or scientific terms used herein have the same meaning as commonly understood by one of ordinary skill in the art to which this invention belongs. These terms, such as commonly used predefined terms, have the same meaning as in the related art and should not be construed as ideal or ambiguous unless explicitly defined in this specification.

Hereinafter, after describing the basic principles of the present disclosure first, the embodiments of the present disclosure will be described in detail.

When a hypervisor 30 efficiently uses computer hardware to operate multiple operating systems at the same time, the hypervisor 30 operates in accordance with its specifications given for each operating system.

If a failure occurs in a specific operating system domain among multiple operating system domains, other operating systems operating in conjunction with the specific operating system domain may not operate properly in accordance with their specifications due to cascading failures.

Meanwhile, since devices such as vehicles, drones, and robots that will be applied in the future use a real-time operating system, if a cascading failure occurs, the real-time operating system will not be able to provide normal service, resulting in failures in systems of cars, drones, and robots.

To solve such cascading failures, a method of applying ASIL decomposition on a hypervisor will be explained as follows.

In the related art, there has been no method of preventing cascading failures due to absence of interface and a function that mutually shares status information with multiple operating systems running on a hypervisor 30.

In other words, according to the related art, when a failure occurs in a certain operating system among multiple operating systems on a hypervisor, other operating systems remain unaware of it. It will lead to greater challenges when such a problem is connected to software that requires the ASIL rating.

In the present disclosure, these problems can be solved in the following manners.

For instance, future hypervisors 30 will need to support operating systems with the ASIL rating in response to the spread of autonomous driving devices such as future vehicles, drones, and robots. Therefore, it is necessary to ensure that multiple operating systems on the hypervisor 30 to operate in accordance with their original specifications.

For this purpose, the present disclosure provides a hypervisor 30 function and interface that allows the hypervisor to receive or determine the status of multiple operating systems and share the status information such as normal operation or faults with multiple operating systems. Furthermore, it provides a mechanism to manage cascading failures by sharing a failure status monitor.

Hereinafter, preferred embodiments of the present disclosure will be described in detail in conjunction with the accompanying drawings.

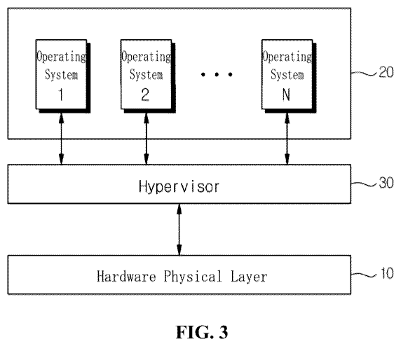

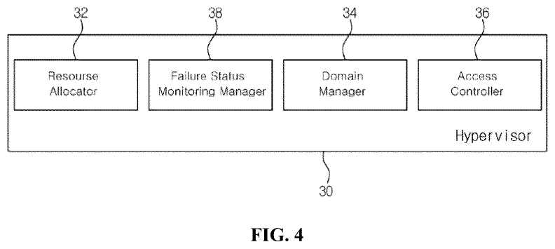

FIG. 3 is a diagram illustrating a monitoring apparatus for monitoring a failure status of operating system domains in a hypervisor system according to an embodiment of the present disclosure. FIG. 4 is a diagram illustrating the configuration of a hypervisor according to an embodiment of the present disclosure.

Referring to FIGS. 3 and 4, a monitoring apparatus for monitoring a failure status of operating system domains in a hypervisor system according to an embodiment of the present disclosure can be configured including a hardware physical layer 10, an operating system layer 20, and a hypervisor 30.

The hardware physical layer 10 is an element constituting a physical device in which a monitoring apparatus for monitoring a failure status of operating system domains in a hypervisor system according to an embodiment of the present disclosure is implemented. For instance, the physical device that configures the hardware physical layer 10 can include a central processing unit or microcontroller unit, a memory device including a dynamic random access memory device, and input and output devices. Whereas these input and output devices can include, but not limited to, storage device, output devices such as a network device and a touch penal, input devices such as a keyboard and a mouse, serial input and output devices, and the like.

The operating system layer 20 constitutes multiple different types of operating systems and control/application software. For instance, the multiple operating systems constituting the operating system layer 20 can be configured to include general purpose operating systems with one or more ASIL degrees such as Windows, Unix and the like, and control/application software can be configured to include software with one or more degrees of ASIL.

The hypervisor 30 is an element that allows multiple operating systems to operate in a virtual machine environment by allocating underlying resources in order to use system resources of the hardware physical layer 10 for each of multiple operating system domains corresponding to multiple operating systems constituting the operating system layer 20.

In addition, the hypervisor 30 has a function of notifying the status of cascading failures for each of multiple operating system domains corresponding to multiple operating systems that constitute the operating system layer 20; allows the multiple operating systems to operate in a virtual machine environment; and has a function of monitoring the failure state.

In addition, the hypervisor 30 collect a failure state for each operating system domain through an interface and shares it with the multiple operating system domains. For instance, the hypervisor 30 can collect a failure state by communicating with the operating system layer 20 through interfaces, monitoring through a watchdog. Examples of interfaces include shared memory, device driver software, and hypercall.

For instance, system resources that the hypervisor 30 allocates for each of multiple operating system domains can include one or more of CPU resources, MCU resources, and memory resources.

Referring to the example of FIG. 4, the hypervisor 30 can be configured to include a resource allocator 32, a domain manager 34, an access controller 36, and a failure status monitoring manager.

The resource allocator 32 allocates resources of system hardware such as CPU and memory for each domain.

The domain manager 34 schedules domains in a time-sharing manner according to the amount of resources allocated by the resource allocator 32, and manages a context switching operation during scheduling.

The access controller 36 controls access between objects such as domains, hardware system resources, and data.

The failure status monitoring manager 38 monitors status information of each of domains, device drivers, and control/application software, and shares them with all operating systems.

For instance, the failure status monitoring manager 38 can be configured to register associated operating system domains through an identification given to operating systems domains on the hypervisor 30, and manage association operations.

For instance, when hardware system resources are CPU resources, an embodiment of the present disclosure uses a failure status monitor manager 38 that constitutes the hypervisor 30 to accurately identify the status (such as failures) of each operating system, and shares its status with operating systems to be able for associated operating system domains to determine whether to continue the association operations or not. Since an operating system domain is guaranteed to operate according to its original specification when operating on a hypervisor 30, in turn, the service of ASIL certified operating systems can guarantee stable operation.

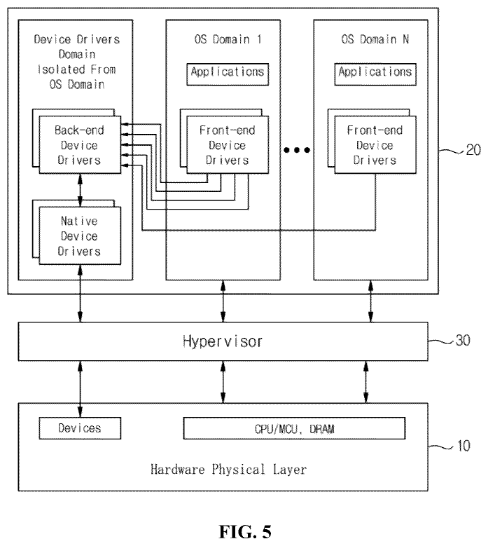

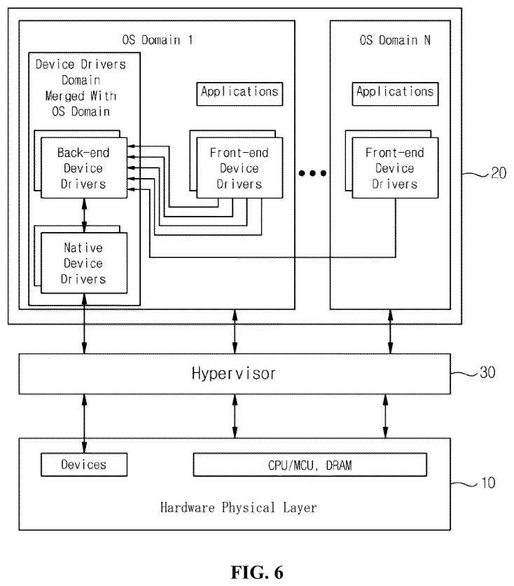

FIG. 5 is a diagram illustrating an example of a system architecture in which a device driver domain is isolated from an operating system domain. FIG. 6 is a diagram illustrating an example of a system architecture in which a device driver domain is incorporated into an operating system domain. An embodiment of the present disclosure can be commonly applied to system architectures illustrated in FIG. 5 and FIG. 6.

As described in detail above, according to the present disclosure, there is an effect of solving a situation where some operating system domains running on the hypervisor cause failures, resulting in cascading failures in which each operating system cannot operate according to its original specification on the hypervisor, leading to a problem where the rest of operating systems, especially operating systems with higher degrees of ASIL cannot properly operate while meeting functional safety requirements.

In addition, there is an effect of fundamentally avoiding cascading failures in operating system domains running on the hypervisor, as a failure status of an individual operating system in the ASIL decomposition software architecture through the failure status information that the hypervisor shares with the operating system domains.

Furthermore, there is an effect of solving a situation where some operating system domains running on the hypervisor cause failures, resulting in cascading failures in which each operating system cannot operate according to its original specification on the hypervisor, leading to a problem where the rest of operating systems, especially operating systems with higher degrees of ASIL and control/application software with higher degrees of ASIL cannot properly operate while meeting functional safety requirements.

### DESCRIPTION OF THE REFERENCE NUMBERS IN THE DRAWINGS

10: hardware physical layer
20: operating system layer
30: hypervisor
32: resource allocator
34: domain manager
36: access controller
38: failure status monitoring manager

What is claimed is:

1. A monitoring apparatus for monitoring a failure status of operating system domains of a hypervisor system, comprising:
a hardware physical layer;
an operating system layer constituting multiple different types of operating systems and control/application software; and
a hypervisor that allocates underlying resources for using system resources of the hardware physical layer in order to operate multiple operating systems in a virtual machine environment, notifies a cascading failure status of each of the multiple operating system domains corresponding to multiple operating systems that constitutes the operating system layer and operate the multiple operating systems in a virtual machine environment, and constitutes a failure status monitoring manager with a failure status monitoring function,
wherein the hypervisor collects the failure status by each of multiple operating system domains via interface and shares them with the multiple operating system domains.

2. The monitoring apparatus of claim 1, wherein the system resources include one or more of central processing unit resources, microcontroller unit resources, and memory resources.

3. The monitoring apparatus of claim 1, wherein the failure status monitoring manager constituting the hypervisor continuously tracks the state such as normal/malfunction state of the associated operating system domains via interface through which the hypervisor collects the state information of a certain operating system domain to share, and notifies the event signals throughout the system upon occurrence of a fault in the operating system domain of the hypervisor system, and delivers these notified event signals to a user.

4. The monitoring apparatus of claim 1, wherein the operating system layer includes an operating system with one or more ASIL degrees, control/application software with one or more ASIL degrees, and one or more general-purpose operating system.

5. The monitoring apparatus of claim 1, wherein the failure status monitoring manager registers associated operating system domains and manages the association operations through an identification given to operating system domains on the hypervisor.
